(19) United States
(12) Patent Application Publication
(10) Pub. No.: US 2014/0349246 A1
(43) Pub. Date: Nov. 27, 2014

(54) ORAL CARE APPLIANCE WITH HYDRODYNAMIC CAVITATION ACTION

(71) Applicant: KONINKLIJKE PHILIPS N.V., EINDHOVEN (NL)

(72) Inventors: Bethany Joyce Johnson, Snoqualmie, WA (US); Tyler G. Kloster, Snoqualmie, WA (US); Johannes Willem Tack, Zuidhorn (NL)

(73) Assignee: KONINKLIJKE PHILIPS N.V., EINDHOVEN (NL)

(21) Appl. No.: 14/368,383

(22) PCT Filed: Dec. 13, 2012
(86) PCT No.: PCT/IB2012/057261

§ 371 Date: Jun. 24, 2014

Related U.S. Application Data
(60) Provisional application No. 61/580,397, filed on Dec. 27, 2011.

(51) Int. Cl. A61C 17/02; A61C 17/22

(52) U.S. Cl. CPC A61C 17/02; A61C 17/225
USPC 433/80; 15/22.1

(57) ABSTRACT

An appliance body which includes a fluid delivery system providing a fluid flow to the appliance body and an exit for the fluid. A cavitation assembly is responsive to the fluid flow, and includes a constriction or obstruction member, wherein the flow rate to and through the cavitation assembly and the flow velocity and other factors results in a cavitation number in the range of 0.1 to 6, so that hydrodynamic cavitation is produced at the exit of the appliance for delivery to a treatment surface.

This invention relates generally to the field of oral care appliances, and more specifically concerns an improvement in the effect of such appliances by an assembly to produce cavitation action in the fluid flow from the appliance.

In order to maintain good oral health during a person's lifetime, it is important to control the presence of oral bio film on the teeth. It is particularly important to control oral biofilm in areas where bristles of a power or manual toothbrush or other oral care appliances cannot reach, particularly along the gumline and between the teeth (interproximal spaces). For toothbrushes, for instance, since toothbrush bristles cannot reach in the gumline or between the teeth, a means of cleaning besides removal by bristles is necessary. Many different approaches have been used to produce such a result. Manual flossing is one approach, but in general, few people are able to maintain a schedule of regular flossing. Other approaches include the use of various implements having particular shapes, including those with particular shaped bristles, which are adapted to physically extend into those areas. These approaches, however, are not particularly effective. Still other approaches include the use of elements which produce acoustic wave action to remove the biofilm.

Although the above approaches have varying results, some more positive than others, the industry and the public are still looking for a toothbrush or other system which is effective in cleaning teeth, including the interproximal areas, as well as being reliable and convenient to use. The system shown and described herein is designed to accomplish those objectives.

Accordingly, the new oral care appliance for treating the surfaces of teeth comprises: an appliance body which includes a fluid delivery system for producing a fluid flow and an outlet for fluid from the appliance; and a cavitation assembly having an inlet and responsive to the fluid flow which includes a constriction or obstruction member, wherein the flow rate to and through the cavitation assembly is such, and wherein the flow velocity is such, that hydrodynamic cavitation bubbles are produced at the exit of the appliance, the hydrodynamic cavitation bubbles moving from the exit to treatment surfaces of teeth.

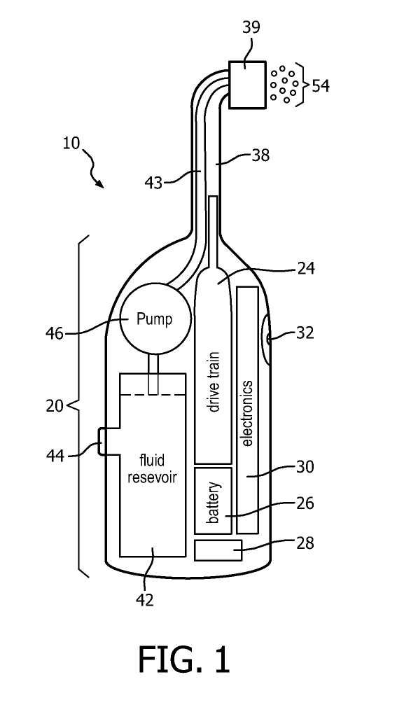

FIG. 1 is a cross-sectional view of a teeth (oral health) cleaning appliance with a hydrodynamic cavitation assembly shown in general.

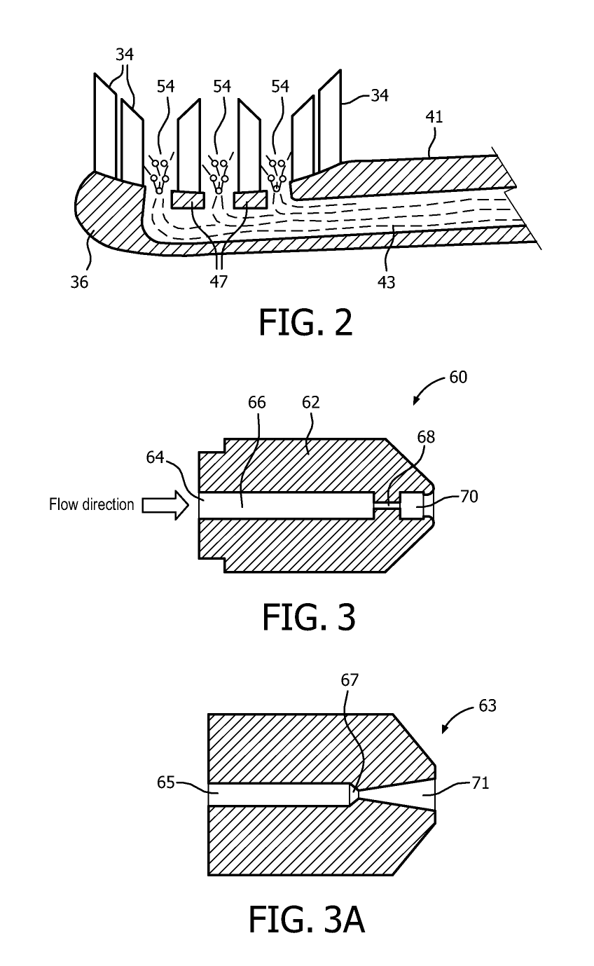

FIG. 2 is a cross-sectional diagram showing the cavitation assembly in the form of a brushhead for a toothbrush.

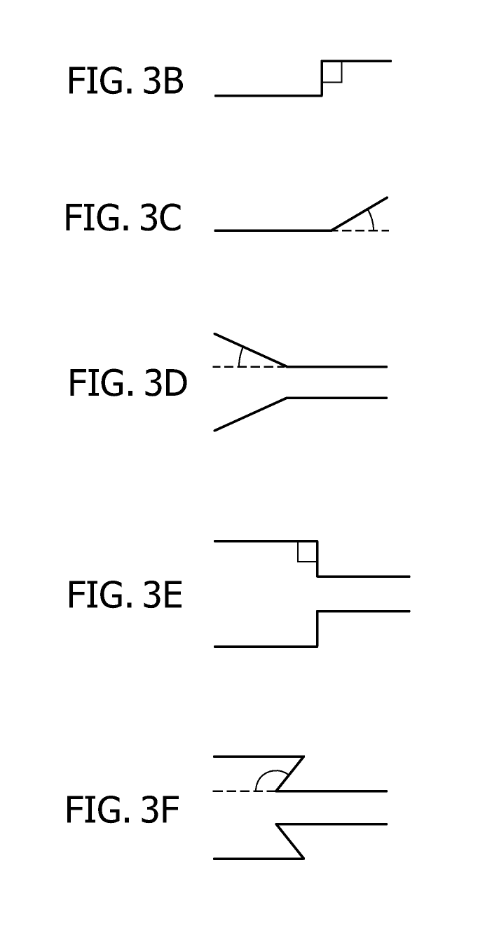

FIGS. 3 and 3A are cross-sectional diagrams of constriction embodiments of the cavitation assembly.

FIGS. 3B-3F are illustrations of outlet and entry angles for the cavitation assembly.

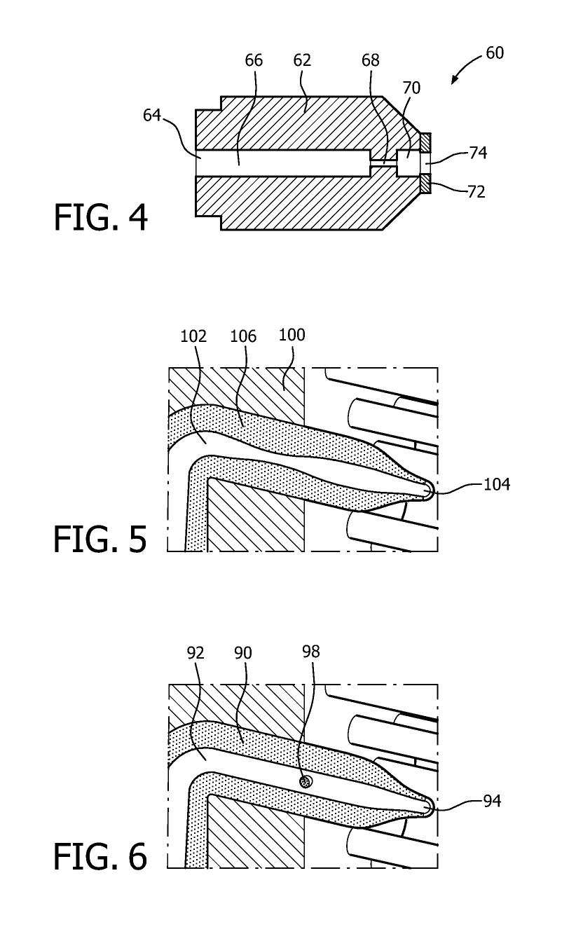

FIG. 4 is a cross-sectional diagram of a modification of the embodiment of FIG. 3.

FIG. 5 is a cross-sectional diagram of another constriction-type embodiment of the cavitation assembly.

FIG. 6 is a cross-sectional diagram of an obstruction-type embodiment of the cavitation assembly.

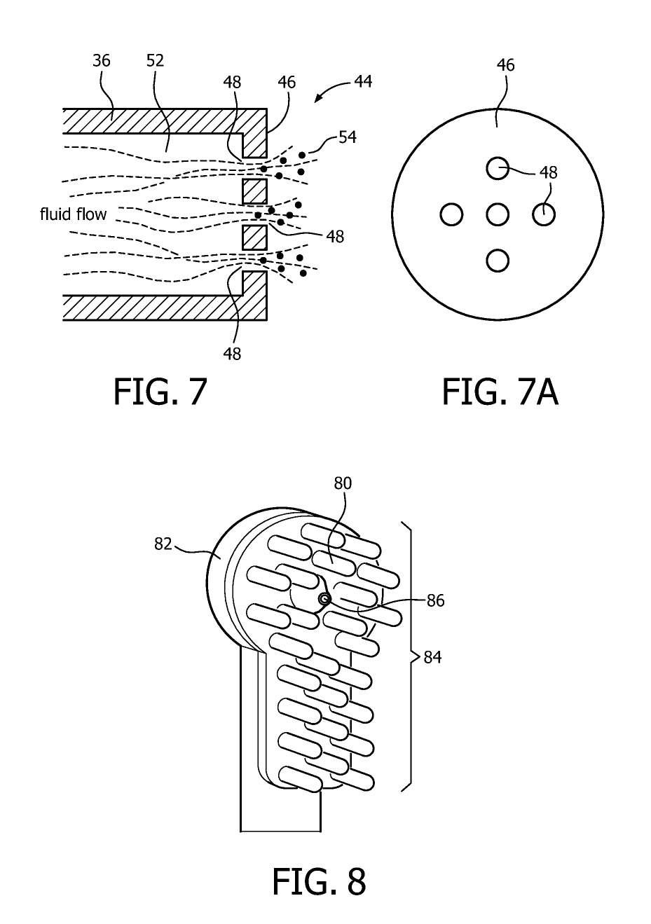

FIGS. 7 and 7A are cross-sectional and end views of another embodiment of the cavitation assembly, with a plate for multiple constrictions.

FIG. 8 is a perspective view of a toothbrush brushhead, with a cavitation jet.

FIG. 1 shows an oral care appliance with a hydrodynamic cavitation capability, the appliance being described in more detail below. In general, there are several known types of cavitation action. The particular cavitation action described herein, with several structural embodiments, is referred to as hydrodynamic cavitation, which is an inertial type of cavitation, in which bubble growth and collapse in a fluid flow through a cavitation assembly occurs due to changes in fluid flow velocity and pressure in and through a cavitation assembly.

In operation, the local fluid pressure drops because of an increase in flow velocity through a constriction or multiple constrictions or around an obstruction in the fluid flow. When the fluid pressure of the liquid flowing through the cavitation assembly drops below the vapor pressure, due to the presence of a constriction or an obstruction present in the path of the flow, vapor bubbles start to grow within the fluid in the cavitation assembly. When the fluid flow deaccelerates, the pressure increases, resulting in the collapse of the bubbles. Preferably, the vapor bubbles grow as they travel along the fluid path in the nozzle, and collapse in a region downstream from the nozzle outlet. Hydrodynamic cavitation action is produced by pressure variations in the flowing liquid due to the internal geometry of the cavitation assembly. Various specific physical arrangements for producing the pressure variation are described below. In addition to those described, there are numerous others which can produce the desired hydrodynamic cavitation action.

The decrease in pressure due to increasing fluid velocity is determined by Bernoulli's Equation: (½)ρv²+ρgz+p=constant, where v=velocity of liquid and p=pressure. Hydrodynamic cavitation can occur in any turbulent fluid. The turbulence produces an area of greatly reduced fluid pressure, such that the fluid vaporizes due to the low pressure, forming a cavity or bubble. When the liquid flow expands at the exit of the cavitation assembly, the pressure increases, which results in the collapse of the bubbles. Inertial (transient) cavitation occurs with rapid growth and then collapse (implosion) of the vapor bubbles in the liquid. During bubble implosion, the surrounding liquid quickly fills the void created by the vapor bubbles, resulting in production and local acceleration of the surrounding fluid, which can dislodge particles on the teeth, as well as removing biofilm.

The cavitation action results in inactivation of microorganisms through a combination of several simultaneously acting mechanisms, including mechanical (physical) effects caused by the generation of turbulence, liquid circulation currents, shear stresses/forces, shock waves, pressure gradients, etc. Microstreaming of the fluid has been found to produce shear stresses sufficient to disrupt bacterial cell membranes. Chemical effects can also be produced, including generation of active free radicals (OH radicals) due to disassociation of vapor trapped in the cavitating bubbles. Further, heat effects are possible as well, such as the generation of local hot spots at the point of collapse of the bubbles.

The combined result of hydrodynamic cavitation is the disruption of and cleaning of oral biofilm from the teeth, producing improved cleaning of the teeth and improved treatment of the gums. Hydrodynamic cavitation thus presents the possibility of significant improvement in oral care through use of an appliance operated by individual users. Various factors/parameters are important in the effectiveness of the cavitation action in the various embodiments described in more detail below.

Important parameters in hydrodynamic cavitation include minimum pressure Pₘᵢₙ, which has an important role in the cavitation action, since pressure is the driving force during bubble growth, effecting both the amount of bubble nuclei which undergo explosive growth and the maximum size reached by the bubbles, Pₘᵢₙ=Pᵢₙ−(½)ρ(vₘₐₓ²−Vₘᵢₙ²)−k, where Pᵢₙ is the inlet pressure, vₘₐₓ is the maximum liquid velocity reached in the cavitation chamber, vᵢₙ is inlet velocity and k is the pressure losses along the liquid path in the cavitation chamber. Other factors include the upstream pressure, such as that produced by the liquid pump in the appliance, the downstream liquid pressure beyond the cavitation assembly, the flow rate of the fluid, the particular cavitation assembly design, the size of the cavitation nozzle, the length of the diffusion throat, the residence time of the fluid in the cavitation chamber which allows the bubble nuclei to grow, the pressure recovery time and turbulence of the fluid flow. In addition, surface roughness can promote cavitation by creating localized low pressure perturbations.

Referring now specifically to FIG. 1, the cavitation appliance is shown at 10, which includes a handle portion 20 and a cavitation assembly portion 39. The handle portion can include a conventional drive train assembly 24 which can be used to drive a brushhead assembly through a selected motion when the appliance is in the form of a power toothbrush. The appliance is powered by a rechargeable battery 26, with a charge coil 28. The operation of the system is controlled by a microprocessor 30 and an on/off button 32. The brushhead also includes a neck portion 38 which extends from handle 20 to a cavitation assembly, shown generally at 39. The neck portion 38 is hollow to permit a flow of liquid (liquid path) to the cavitation assembly.

Also positioned in the handle is a liquid reservoir 42 with a liquid fill inlet 44 and a pump 46 which is capable of pumping fluid from reservoir 42 through liquid path 47 to the cavitation assembly, which in operation produces cavitation bubbles 41. The liquid in the reservoir can be water, or it could also be other liquids, including water with various additives, mouthwash, a dentifrice or hydrogen peroxide or others.

A cavitation assembly arrangement using a constriction is shown in FIGS. 3 and 3A. In FIG. 3, the cavitation assembly 60 includes an assembly body 62. The liquid flow from the reservoir in the handle moves through an inlet 64 into a channel 66, where it encounters a constriction opening 68 at the distal end thereof. In this embodiment, to produce cavitation, the diameter of channel 66 is approximately 0.5 mm to 15 mm; with a preferred range of 1-3 mm. The diameter of the constriction 68 is approximately 0.1-10 mm, with a preferred range of 0.5-1.0 mm. The length of the constriction 68 is approximately 0.1 mm to 25 mm, with a preferred range of 0.5-3 mm. In the embodiment of FIG. 3, there is an outlet region 70 at the exit of the constriction opening, the outlet having a diameter in the range of 0.5 mm to 15 mm, with a preferred range of 1 mm-3 mm. The length of the outlet 20 has a range of 0-25 mm, with a preferred length of 1-6 mm.

FIG. 3A is a venturi design cavitation assembly 63, with an inlet channel 65, a venturi region 67 and an outlet region 71.

The ranges above are generally valid to produce cavitation for the embodiments of FIGS. 3 and 3A. The embodiment of FIG. 4 includes a spacer 72 at the end of the outlet. The spacer has an opening 74 which is approximately 1.5 mm. The spacer could be made from flexible material. The spacer creates a buffer zone between the constriction, the outlet region and the spacer. The buffer zone aids in the growth and the travel of the cavitation bubbles for delivery to the teeth surfaces, including the interproximal spaces.

The embodiments of FIGS. 3, 3A and 4 include outlet and inlet angles. The range for the outlet angle is 90° to 0.5°, with a preferred range of 4-8°, which preferred angle produces a gradually diverging outlet and is illustrated generally in FIG. 3A. The 90° angle embodiment is shown in FIG. 3. The range for the inlet angle is 45° to 135°, with the 90° angle being shown in FIG. 3. The outlet angles are illustrated in FIGS. 3B and 3C, while various inlet angles are shown in FIGS. 3D-3F.

FIG. 5 shows a cavitation assembly 100 in an inlet fluid channel 102 and an outlet 104. In channel 102, there is a narrow region 106 which produces a venturi effect. Above a threshhold fluid flow velocity, the result is hydrodynamic cavitation (vapor bubbles) beyond outlet 104, producing the desired cleaning effect on biofilm.

A common method of quantifying hydrodynamic cavitation is by use of the cavitation number. The cavitation number can indicate under which fluid dynamic properties cavitation inception can be expected. The cavitation number Cv is determined as follows:

Cv=(Pa−Pv)/((½)(p)(v)̂2)
where Pa=pressure downstream of the constriction (atmospheric pressure), Pv=vapor pressure of the fluid, v=average velocity in the constriction or at the orifice, and p=density of the fluid.
   The main operating parameter is the fluid flow velocity v in m/c. Cavitation begins at a threshhold flow velocity. By increasing the fluid flow velocity beyond the threshhold velocity at lower cavitation numbers, the cavitation will be more intense.

The operating range for an oral care cavitation assembly: 0.1 to 6 (less than 6); the preferred range: 0.1 to 1 (less than 1); the optimum range: 0.3 to 0.5, as determined from balancing the vapor bubble density and user comfort.

The cavitation number equation is in principal independent of geometrical scale. The number has first order validity, because the gas saturation and fluid temperature, for example, can have an influence on the exact level of the vapor pressure Pv of the type of fluid used. Vapor pressures under various conditions are documented in the relevant available literature. The average flow velocity in the constricted area is 5 m/s to 50 m/s for tap water. The preferred range is 20 m/s to 30 m/s, again for tap water. The flow can be continuous or intermittent. For intermittent flow, the time duration range is 0.02 seconds to 2 seconds. The preferred time duration range for intermittent flow is 0.1-0.5 seconds at the threshhold flow velocity.

Orientation of the fluid stream coming out of the nozzle may be a focused jet, or a diverging stream depending on the outlet channel geometry. This influences reach of the vapor bubbles.

FIG. 6 shows a cavitation assembly, in the form of a cavitating jet which includes a fluid channel 92 in the body of the cavitating jet member which narrows to an exit opening 94. Positioned within the fluid path prior to the exit opening is an obstruction element 96, which produces the cavitation action; the obstruction element is typically in the form of a pin member 98 which extends across the fluid channel. In this arrangement, the diameter of the fluid channel 92 and the diameter of the pin are approximately the same as for the constriction embodiment described above. The pin could be circular or have sharp edges in cross-section or have other configurations. The other aspects of the operation of the pin obstruction embodiment, such as fluid flow rates, output diameter, output length, etc. are substantially the same as for the constriction embodiments disclosed above.

Another cavitation assembly 44 is shown generally in FIGS. 7 and 7A as a cavitation plate 46, with openings 48 therethrough. Spaced openings 48 are provided in plate 46. The plate 46 with openings 48 form another embodiment of constriction in the cavitation assembly. The plate 46 can take various configurations, including circular, as shown in FIG. 7A. The plate may also be elliptical or rectangular or other similar shape so as to fit in a brushhead member. In this constriction arrangement, orifice plate 46 includes one or more openings 48 which allow liquid 52 to pass through the orifice plate to produce hydrodynamic cavitation downstream of orifice plate 46. The resulting bubbles are shown at 54 in FIG. 7. The thickness of the orifice plate, in this case approximately 0.5-3 mm is sufficient to produce the required increase in flow velocity through the constriction (the openings) which results in the required fluid pressure drop through the constriction. As the pressure drops below the threshhold pressure for cavitation, cavitation bubbles begin to grow. They collapse at the exit of the orifice plate, when the pressure again rises, as described in detail above. In this embodiment, the openings are approximately 0.5-1.0 mm in diameter. The size of the openings can vary to some extent, even among the openings in the plate. There are a plurality of openings, which can be described by a dimensionless parameter βₒ, which is defined as the ratio of the sum of the hole (opening) area(s) of an orifice plate to the upstream fluid area, in %. For example, a βₒ value of 20% means 80% of the fluid area is blocked. βₒ in the present embodiment is 1%-90% with a preferred range of 2% to 50%.

The above cavitation constriction arrangements result in hydrodynamic cavitation which is efficient, comfortable and safe, since it involves pressure changes in a liquid flow and not high frequencies, as is necessary with other types of cavitation. The cavitation bubbles created in the cavitation assembly expand and they implode downstream of the assembly exit, producing shear stress and mechanical effects on biofilm present on the teeth, particularly in the interproximal regions and beneath the gum line. The vapor bubble travel distance is within the range of 0 mm to 20 mm, radiating from the nozzle outlet. The typical range is 0 m to 6 mm.

The appliance can take various functional teeth cleaning implementations, including a manual toothbrush, a power toothbrush, an oral irrigator, a water flosser, embodiments designed for interproximal and below the gumline cleaning, including professional appliances as well as home appliances. The treatment surface can include, among others, oral hard tissue, oral appliances or oral soft tissue.

A brushhead for a power toothbrush for instance is shown in FIG. 2. At the distal end of a neck portion 41 of a brushhead is a set of conventional bristles 34 mounted on a bristle base member 36. The neck portion 41 is hollow to permit a flow of fluid 43 therethrough. A cavitation plate 47 similar to that shown in FIGS. 7 and 7A is positioned in an opening in the upper surface of the bristle base member. Bristles 34 are also mounted on cavitation plate 47. Cavitation bubbles 54 appear upon exit of fluid from openings in plate 47.

FIG. 8 shows a power toothbrush embodiment with a cavitation jet member 80, which extends from a bristle base member 82, with bristles 84, and which has an exit opening 86 from which fluid exits. The cavitation jet may include various constrictions or obstructions, as disclosed above.

FIGS. 5, 6 and 8 all include a rubber nozzle tip which has an offset comparable to the flexible material spacer of FIG. 3.

Hence, several embodiments of a power toothbrush have been disclosed using conventional bristles and resulting toothbrush action in combination with a hydrodynamic cavitation assembly present in the base plate or extending from the base plate for the bristles. Hydrodynamic cavitation depends upon a change of fluid velocity and pressure to produce the desired cavitation action, which has an effect on the oral bio film on the teeth in addition to the effect of the bristles. An enhanced cleaning effect is produced as well as a treatment action on the gums, including the interproximal area between the teeth and at the gum line.

Although a preferred embodiment of the invention has been disclosed for purposes of illustration, it should be understood that various changes, modifications and substitutions may be incorporated in the embodiment without departing from the spirit of the invention which is defined by the claims which follow:

1. An oral care appliance for treating the surfaces of teeth, comprising:
an appliance body which includes a fluid delivery system for producing a fluid flow and an outlet for fluid from the appliance; and
a cavitation assembly having an inlet and responsive to the fluid flow which includes a constriction or obstruction member, wherein the flow rate to and through the cavitation assembly is such, and wherein the flow velocity is such, that hydrodynamic cavitation bubbles are produced at the exit of the appliance, the hydrodynamic cavitation bubbles moving from the exit to treatment surfaces of teeth.

2. The oral care appliance of claim 1, wherein the fluid flow to the cavitation assembly is continuous or intermittent.

3. The oral care appliance of claim 1, wherein the cavitation assembly includes a fluid entry main channel, followed by a constriction channel and an outlet.

4. The oral care appliance of claim 3, including a spacer element at a distal end of the outlet, the spacer element being arranged and configured to produce a buffer zone between the constriction element, the outlet portion and the spacer, such that within the buffer zone, the pressure remains sufficiently low to allow the cavitation bubbles to travel further to the treatment surfaces.

5. The oral care appliance of claim 1, wherein the cavitation assembly includes an obstruction member which extends across the fluid channel.

6. The oral care appliance of claim 5, wherein the obstruction member is a pin and wherein the pin member has a diameter which is approximately 50% of the diameter of the fluid channel.

7. The oral care appliance of claim 1, wherein the obstruction member is a grid member.

8. The oral care appliance of claim 1, wherein the cavitation assembly includes a constriction member which comprises a plate having a plurality of openings therethrough.

9. The oral care appliance of claim 1, wherein the cavitation assembly includes a constriction element in the form of a narrow region of the fluid channel arranged to produce a venturi effect and cavitation bubbles at the outlet thereof.

10. The oral care appliance of claim 1, wherein the cavitation number for the appliance is within the range of 0.1-6.

11. The oral care appliance of claim 1, wherein the cavitation number is within a preferred range of 0.1-1.

12. The oral care appliance of claim 1, wherein the cavitation number is within a most preferred range of 0.3-0.5.

13. The oral care appliance of claim 1, wherein the cavitation assembly has an inlet with a diameter within the range of 0.5 mm to 15 mm.

14. The oral care appliance of claim 13, wherein the inlet diameter has a preferred range of 1 mm to 3 mm.

15. The oral care appliance of claim 1, wherein the constriction member has a diameter in the range of 0.1 to 10 mm.

16. The oral care appliance of claim 15, wherein the constriction member has a diameter in a preferred range of 0.5 mm to 1.0 mm.

17. The oral care appliance of claim 1, wherein the constriction member has a length in the range of 0.1 mm to 25 mm.

18. The oral care appliance of claim 17, wherein the constriction member has a length in preferred range of 0.5 mm to 3 mm.

19. The oral care appliance of claim 1, wherein the outlet has a diameter in the range of 0.5 mm to 15 mm.

20. The oral care appliance of claim 19, wherein the outlet has a diameter in a preferred range of 1 mm to 3 mm.

21. The oral care appliance of claim 1, wherein the outlet portion has a length within the range of 0 mm to 25 mm.

22. The oral care appliance of claim 21, wherein the outlet has a length within a preferred range of 1 mm to 6 mm.

23. The oral care appliance of claim 1, wherein the outlet has an outlet angle in the range of 90° to 0.5°.

24. The oral care appliance of claim 23, wherein the outlet has an outlet angle in the range of 4° to 8°.

25. The oral care appliance of claim 1, wherein the inlet has an angle in the range of 45° to 135°.

26. The oral care appliance of claim 25, wherein the inlet angle is within the range of 60° to 100°.

27. The oral care appliance of claim 1, wherein the oral care appliance is a power toothbrush.

28. The oral care appliance of claim 1, wherein the oral care appliance is a flossing device for use in the interproximal spaces.

29. A power toothbrush, comprising:
a handle, which includes a fluid reservoir, a fluid pump, a drive assembly, a control assembly and a power supply assembly; and
a brushhead assembly with a brushhead member at the distal end thereof, the brushhead assembly including a set of bristles mounted on a bristle base, and a cavitation assembly, wherein a change of fluid flow past a constriction member or an obstruction member in a fluid channel portion of the cavitation assembly produces hydrodynamic cavitation at an outlet of the cavitation assembly, with a cavitation number within the range of 0.1 to 1.
